(19) United States
(12) Patent Application Publication
(10) Pub. No.: US 2010/0240294 A1
(43) Pub. Date: Sep. 23, 2010

(54) HEATING, VENTILATING, AND AIR CONDITIONING MODULE

(75) Inventor: Gerald M. Goupil, JR., N. Tonawanda, NY (US)

Correspondence Address: DELPHI TECHNOLOGIES, INC, M/C 480-410-202, PO BOX 5052, TROY, MI, 48007, US

(73) Assignee: DELPHI TECHNOLOGIES, INC., Troy, MI (US)

(21) Appl. No.: 12/406,274

(22) Filed: Mar. 18, 2009

(51) Int. Cl. B60H 1/00; B21D 53/02

(52) U.S. Cl. 454/160; 29/890.03

(57) ABSTRACT

An HVAC module for controlling the temperature inside a vehicle and including a housing of a first material being pliable in response to a predetermined force. A blower assembly is disposed adjacent to the inlet of the housing for propelling a flow of air into the air channel. A frame defining a skeleton supports the housing and the blower assembly on the vehicle, and the frame is of a second material for maintaining structural integrity in response to a force greater than the predetermined force. The skeleton of the frame includes a plurality of hoops parallel to and spaced from each other and a plurality of stringers interconnecting the hoops. A plurality of beams and a metal spine extend outwardly from one of the hoops to engage the blower assembly.

### BACKGROUND OF THE INVENTION

1. Field of the Invention

A heating, ventilating, and air conditioning (HVAC) module for controlling the temperature and distribution of air in the cabin of a vehicle.

2. Description of the Prior Art

Generally, HVAC modules include a hollow housing. Heat exchangers, airflow creation devices, and/or airflow directing devices are typically disposed in the housing of the HVAC module. These components, in cooperation, receive, temper and redirect a flow of forced air from an upstream blower assembly to and through a downstream outlet to be dispensed to the cabin of the vehicle.

One such HVAC module is disclosed in U.S. Pat. No. 5,709,601, issued to Thomas Heck on Jan. 20, 1998 (hereinafter referred to as Heck '601). Heck '601 shows an HVAC module including a housing of a first material being pliable in response to a predetermined force. The housing defines an inlet and an outlet and an air channel extending between the inlet and the outlet. A blower assembly is disposed adjacent the inlet of the housing for drawing air into the air channel through the inlet of the housing.

There is a continuing need for HVAC modules that are smaller and lighter. Reducing the size of the HVAC module allows room for either a smaller vehicle, a more spacious interior or more space available to package on-board focused electronics, e.g. navigation systems. It is also desirable to reduce the weight of an automobile's HVAC module in order to improve the vehicle's performance and fuel economy.

### SUMMARY OF THE INVENTION

The invention provides for such an HVAC module and further including a frame defining a skeleton of a second material for maintaining structural integrity in response to a force greater than the predetermined force and for supporting the housing and the blower assembly on the vehicle.

The frame of the subject invention provides the structural integrity of the HVAC module, and therefore, the housing can be made of a thinner, lighter, and/or more cost effective material than the housings of the prior art HVAC modules. The subject invention also has additional manufacturing and transportation advantages. For example, a lighter HVAC module of the subject invention can be installed into the vehicle quicker and easier than the HVAC modules of the prior art. Potentially, any lift-assist mechanism on the assembly line for installing the HVAC module into the vehicle could be eliminated. The housing could also be made of a clear material, which would allow for easy inspection either during assembly or during the life of the HVAC module.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of the subject invention with the frame disposed about and engaging the housing and the blower assembly;

FIG. 2 is a cross-sectional view of the subject invention;

FIG. 3 is a perspective and broken away view of an alternate embodiment of the frame and the housing of the subject invention; and

FIG. 4 is a perspective view of the insert of the exemplary embodiment.

### DETAILED DESCRIPTION OF THE EXEMPLARY EMBODIMENTS

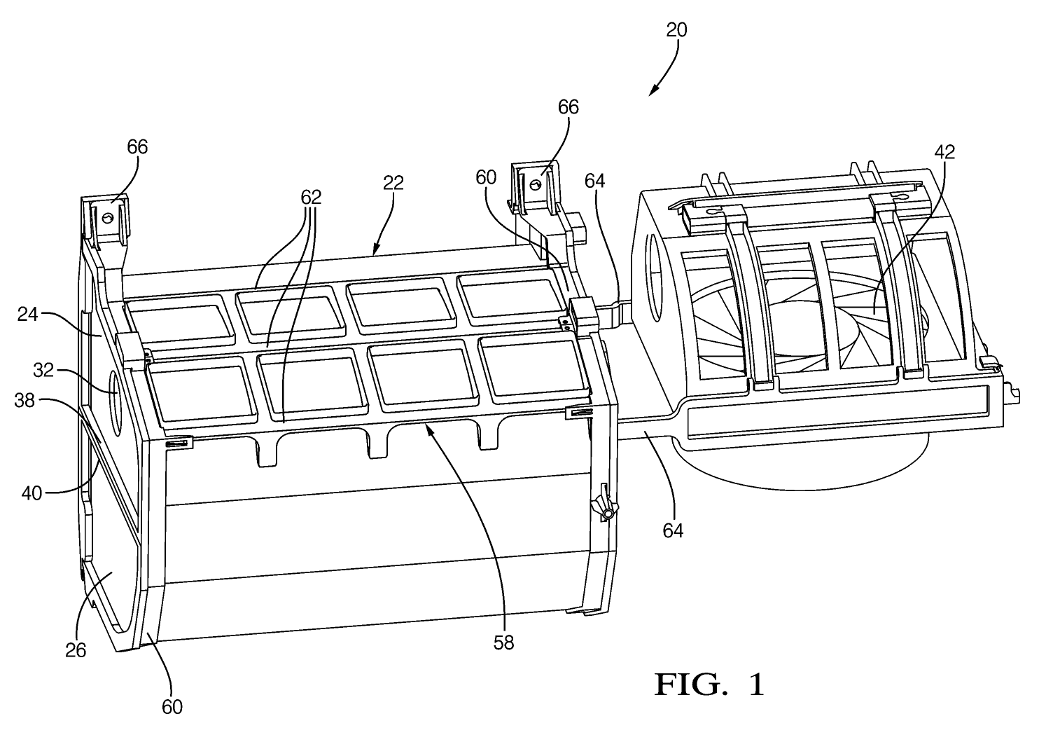

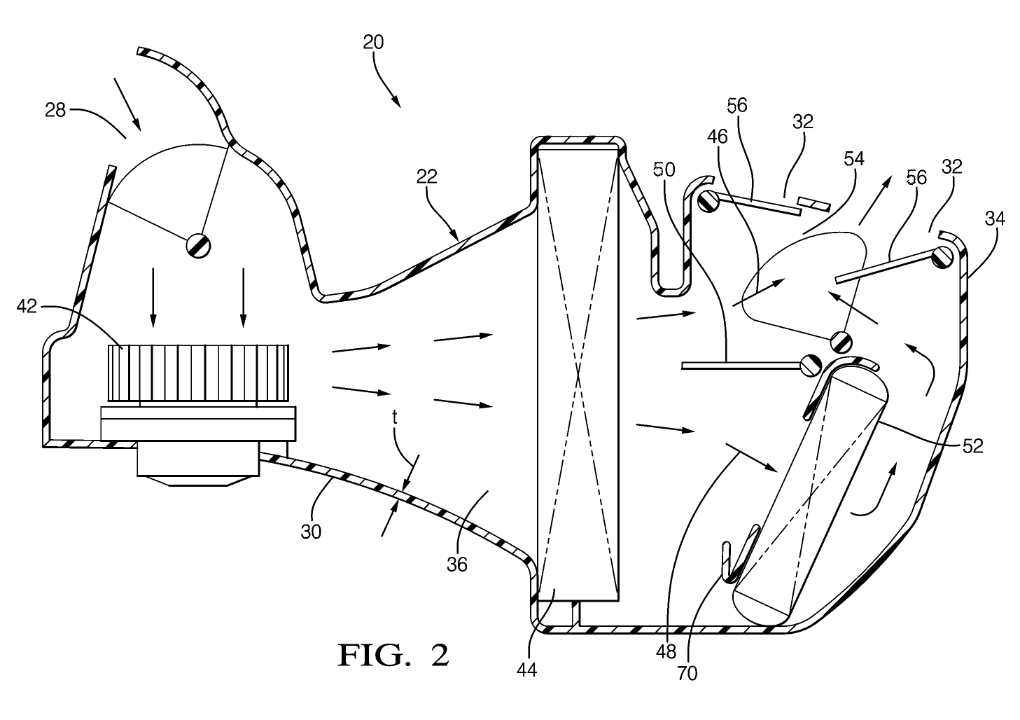

Referring to the Figures, wherein like numerals indicate corresponding parts throughout the several views, the invention includes an HVAC module 20, generally shown in FIGS. 1 and 2, for controlling the temperature and distribution of air within the inside of a vehicle.

The HVAC module 20 includes a housing 22, generally indicated in FIG. 1 and 2, composed of a first shell 24 and a second shell 26. The first and second shells 24, 26 of the housing 22 are of a first material being pliable in response to a predetermined force.

The housing 22 defines an inlet 28 disposed on one end for receiving a flow of air and for defining an upstream side 30 of the housing 22. The housing 22 defines at least one outlet 32 for dispensing the flow of air to one or more zones of the vehicle. The outlets 32 are disposed on the opposite end of the housing 22 from the inlet 28 to define a downstream side 34 of the housing 22. An air channel 36 extends from the inlet 28 on the upstream side 30 of the housing 22 to the outlets 32 on the downstream side 34 of the housing 22 for conveying the flow of air there between. In the exemplary embodiment, the housing 22 is thermoformed and has a thickness t in the range of 0.10 to 1.00 mm. However, the housing 22 could be formed using any other manufacturing technique, including but not limited to injection molding and blow molding. Holes or apertures required in the housing 22 could be formed within the mold or by a secondary cutting operation.

As indicated above, in the exemplary embodiment, the housing 22 is composed of a first shell 24 and a second shell 26. However, the housing 22 could be made of any number of shells 24, 26.

In the exemplary embodiment, the first shell 24 defines a first rim 38 and the second shell 26 defines a second rim 40. The first and second rims 38, 40 are aligned with one another and the first and second shells 24, 26 are welded together to define the unified housing 22. The first and second shells 24, 26 could also be snapped together or adhesively attached or joined in any other process to define the unified housing 22.

In the exemplary embodiment, a blower assembly 42 is disposed externally of and adjacent to the inlet 28 of the housing 22 for drawing air into the air channel 36 from inlet 28 of the housing 22. The blower assembly 42 could be disposed externally or internally of the housing 22. An evaporator 44 is disposed in the air channel 36 of the housing 22 for dehumidifying and cooling the flow of air received from the inlet 28. Downstream of the evaporator 44, the air channel 36 transitions into a cool air path 46 and a heated air path 48 extending in parallel relationship to one another. A temperature valve 50 is disposed between the cool and heated air paths 46, 48 for apportioning the flow of cool air delivered from the evaporator 44 between the cool air path 46 and the heated air paths 48. A heater core 52 is disposed in the heated air path 48 of the air channel 36 for heating the flow of air apportioned into the heated air path 48 by the temperature valve 50.

The housing 22 defining a mixing chamber 54 disposed downstream of the cool and heated air paths 46, 48 for receiving and mixing the cool and dehumidified air from the evaporator 44 apportioned through the cool air path 46 and the hot air from the heater core 52 apportioned through the heated air path 48. At least one zone valve 56 is disposed between the mixing chamber 54 and the outlets 32 for apportioning the flow of air from the mixing chamber 54 to the desired outlet 32 for directing the air to the desired vehicle zone. The zones of the vehicle can be the floor vents in the cabin of the vehicle, the dashboard vents in the cabin of the vehicle, and the windshield in the cabin of the vehicle or they could be any other region of the vehicle.

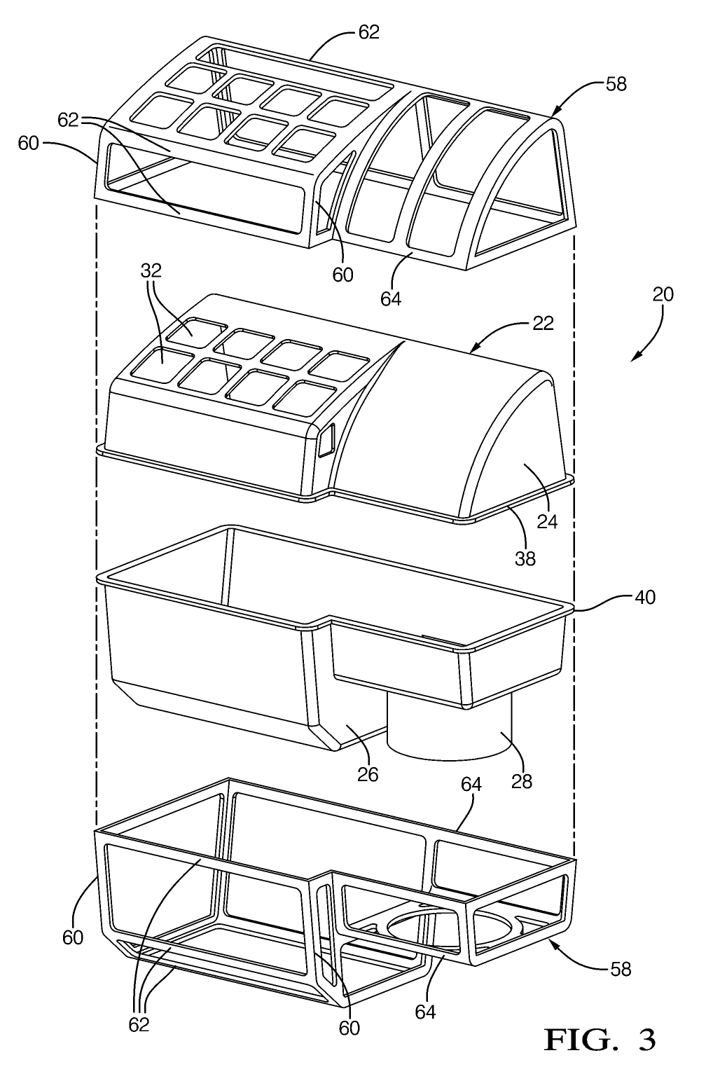

The HVAC module 20 further includes a frame 58, generally indicated in FIGS. 1 and 3, defining a skeleton of a second material for maintaining structural integrity in response to a force greater than the predetermined force and for supporting the housing 22 and the blower assembly 42 on the vehicle. The second material of the frame 58 of the exemplary embodiment is of a polymeric material, but any other material capable of maintaining structural integrity in response to a force greater than the predetermined force may also be used.

The skeleton of the frame 58 defines a plurality of hoops 60 parallel to and spaced from each other. A plurality of stringers 62 being spaced from each other interconnect the hoops 60. The skeleton of the frame 58 further defines a plurality of beams 64 extending outwardly from one of the hoops 60 of the frame 58 to engage the blower assembly 42 for supporting the blower assembly 42 adjacent the housing 22. Each of the hoops 60 of the frame 58 defines a flange 66 for mounting the frame 58 to the vehicle. Although the Figures only show the flanges disposed on the hoops 60, the spine 68, stingers 62, or housing 22 could also define flanges and are meant to be included in the scope of the invention. The frame 58 may also form valve seats for the temperature valve 50 and/or the zone valve 56. Additionally, the frame may define a sealing surface for at least one of the valves 50, 56.

In the exemplary embodiment, a spine 68 of metal interconnects the hoops 60 of the frame 58 and extends outwardly from the frame 58 to engage the blower assembly 42 for reinforcing the support of the blower assembly 42 by the frame 58. The spine 68 may be of any material capable of reinforcing the support of the blower assembly 42 by the frame 58. Depending on various factors, including the distance of the blower assembly 42 from the housing 22 and the strength of the second material, the spine 68 and/or the plurality of beams 64 might not be necessary. Similar to the frame 58, the spine 68 may be of any material suitable for reinforcing the support of the blower assembly 42.

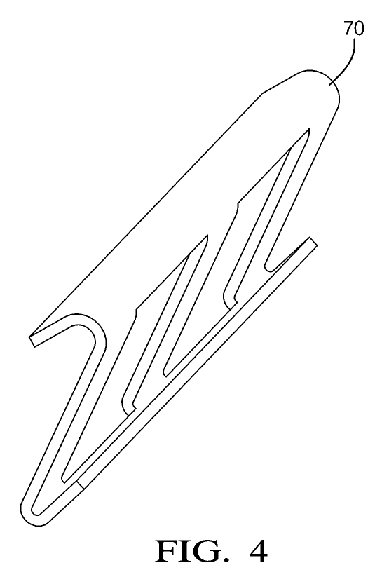

In another embodiment of the invention, a plurality of inserts 70 are disposed inside the housing 22. The inserts 70 can be used to form valve seats for the temperature valve 50, to form valve seats for the zone valve 56, to support/orient the evaporator 44, to support/orient the heater core 52, to direct air through the air channel 36, to create chambers in the housing 22, or to create sealing surfaces for the various parts of the invention. The inserts 70 and the temperature valve 50 and/or the heater core 52 and/or the evaporator 44 can be built as a subassembly that is inserted into the first shell 24 during the manufacturing process. It should be appreciated that the subassembly could also be inserted into the second shell 26. The inserts 70 can be formed from any manufacturing method, including but not limited to thermoforming. FIG. 4 shows an insert 70 being used as a valve seat.

The invention further includes a method of fabricating an HVAC module 20 for controlling the temperature and distribution of air within the inside of a vehicle. The method starts with the step of forming a first shell 24 of a first material pliable in response to a predetermined force. The first shell 24 of the exemplary embodiment is formed on a first mold and defines an air channel 36 and a mixing chamber 54. The method continues with the step of inserting an evaporator 44 for cooling and dehumidifying the flow of air into the air channel 36 of the first shell 24. The method proceeds with the step of inserting a temperature valve 50 in the air channel 36 between the evaporator 44 and the mixing chamber 54 of the first shell 24 to define a dehumidified and cool air path 46 on one side of the temperature valve 50 and a heated air path 48 on the other side of the temperature valve 50. The temperature valve 50 apportions the flow of cool air delivered from the evaporator 44 between the cool and heated air paths 46, 48. The method proceeds with the step of inserting a heater core 52 into the heated air path 48 of the first shell 24 for heating the flow of air apportioned into the heated air path 48 by the temperature valve 50. The mixing chamber 54 receives the flow of air from the cool and heated air paths 46, 48 and mixes those flows of air. The method proceeds with the step of inserting at least one zone valve 56 in the air channel 36 of the first shell 24 for apportioning the flow of air from the mixing chamber 54 to a first vehicle zone and to a second vehicle zone. It should be appreciated that the components could be inserted into the second shell 26 instead of the first shell 24. It should also be appreciated that many other combinations in assembly order are possible and the invention is not limited to the order of steps recited above.

The method then continues with the step of forming a second shell 26 of the first material on a second mold. The first and second shells 24, 26 may be formed by any known manufacturing method including, but not limited to thermoforming, blow molding and injection molding. The method proceeds with the step of attaching the first and second shells 24, 26 to define a unified housing 22. In the exemplary embodiment, the first shell 24 defines a first rim 38, and the second shell 26 defines a second rim 40, and the step of attaching the first and second shells 24, 26 is further defined as aligning the first and second rims 38, 40 and welding the second shell 26 to the first shell 24 to define the unified housing 22. The first and second shells 24, 26 may also be snap-fit together, adhesively attached, or joined by any other known method. Alternatively, the second shell 26 could be formed using the same mold as the first shell 24 with a living hinge disposed between the first and second shells 24, 26.

The method continues with the step of forming an inlet 28 in the housing 22 for receiving a flow of air and for delivering the flow of air to the air channel 36 of the housing 22. The method then continues with the step of forming at least one outlet 32 in the housing 22 for dispensing the flow of air to one or more zones in the cabin of the vehicle. The inlet 28 and outlets 32 could be formed concurrently with the forming of the first or second shells 24, 26.

In the exemplary embodiment, the method continues with the step of inserting a blower assembly 42 externally of and adjacent to the inlet 28 of the housing 22 for drawing the flow of air through the inlet 28 and into the air channel 36 of the housing 22. Alternatively, the blower assembly 42 could also be disposed inside of the housing 22 adjacent the inlet 28, and is meant to be included in the scope of the invention.

In order to support the housing 22, the method proceeds with the step of injection molding a frame 58 defining a skeleton and having a plurality of hoops 60 and stringers 62. The hoops 60 are parallel and spaced from each other, and the stringers 62 are spaced from each other to interconnect the hoops 60. The method proceeds with the step of engaging the skeleton of the frame 58 to the housing 22 and the blower assembly 42 to maintain structural integrity in response to a force greater than the predetermined force and for supporting the housing 22 and the blower assembly 42 on the vehicle. The method is completed with the step of engaging a spine 68 of metal to the hoops 60 of the skeleton of the frame 58 and to the blower assembly 42 for reinforcing the support of the blower assembly 42 by the frame 58. Depending on the distance between the housing 22 and the blower assembly 42, the spine 68 might not be needed.

The frame 58 could be a single, unified skeleton or it could be formed into two or more pieces that are attached together using any known method of attachment, e.g. welding, snap-fitting, adhesively securing, etc.

The method also may include the step of inserting at least one insert 70 into the air channel 36 of the first shell 24 or second shell 26. The inserts 70 can be used for a number of functions, for example, they can form valve seats for the temperature or zone valves 50, 56, support/orient the evaporator 44 or heater core 52, or direct air through the air channel 36. The insert 70 (s) also could be an orifice plate over the fan or a close out plate for the evaporator 44 pipes. The inserts 70 can be made using any known manufacturing process, e.g. thermoforming, injection molding, etc.

In another embodiment of said invention, the method includes the step of forming a subassembly including any of an insert 70, a zone valve 56, the temperature valve 50, the evaporator 44, or the heater core 52. This embodiment further includes the step of inserting the subassembly into the first shell 24 or second shell 26 before the step of attaching the first and second shells 24, 26 to define the unified housing 22.

In another embodiment of the invention, the step of forming the skeleton of the frame 58 precedes the steps of forming the first and second shells 24, 26. This embodiment includes the step of inserting the skeleton of the frame 58 into the first mold before thermoforming the first shell 24. The first shell 24 forms about the skeleton of the frame 58 and engages that skeleton. The method then continues with the step of inserting other side of the frame 58 into the second mold and thermoforming the second shell 26 about the skeleton of the frame 58 to engage the frame 58 to the housing 22.

In yet another embodiment, the second shell 26 is formed using the same mold as the first shell 24. This embodiment includes the step of thermoforming the first and second shells 24, 26 concurrently with a living hinge disposed between the first and second shells 24, 26. This embodiment may include the step of inserting the skeleton of the frame 58 into the single mold and thermoforming the first and second shells 24, 26 about the skeleton of the frame 58 to engage the frame 58 to the housing 22.

In another embodiment of the invention, the method includes the step of forming at least one of the first and second shells 24, 26 within a mold and moving the features within the mold to reconfigure the internal geometry of the mold. This embodiment continues with the step of forming the skeleton of the frame 58 in the same mold as the one of the first and second shells 24, 26. At last one of the first and second shells 24, 26 forms about the skeleton of the frame 58 and engages that skeleton. The process could be repeated for forming the other of the first and second shells 24, 26, or the first and second shells 24, 26 could be formed concurrently in the same mold creating a living hinge disposed between the first and second shells 24, 26. In this embodiment, the first and second shells 24, 26 and the skeleton would all be formed using a single mold.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An HVAC module for controlling the temperature inside a vehicle comprising:
a housing of a first material being pliable in response to a predetermined force;
said housing defining an inlet and an outlet and an air channel extending between said inlet and said outlet for conveying a flow of air therebetween;
a blower assembly for propelling the flow of air into said air channel through said inlet of said housing; and
a frame defining a skeleton of a second material for maintaining structural integrity in response to a force greater than said predetermined force and for supporting said housing and said blower assembly on the vehicle.

2. The assembly as set forth in claim 1 wherein said skeleton of said frame includes a plurality of hoops parallel and spaced from each other.

3. The assembly as set forth in claim 2 wherein said skeleton of said frame further includes a plurality of stringers being spaced from each other and interconnecting said hoops.

4. The assembly as set forth in claim 2 wherein said blower assembly is disposed adjacent to said inlet of said housing.

5. The assembly as set forth in claim 4 wherein said skeleton of said frame defines at least one beam extending outwardly from one of said hoops to engage said blower assembly for supporting said blower assembly adjacent said housing.

6. The assembly as set forth in claim 5 further including a plurality of beams extending outwardly from said hoops to engage said blower assembly.

7. The assembly as set forth in claim 5 further including a spine interconnecting said hoops of said frame and extending outwardly from said frame to engage said blower assembly for reinforcing the support of said blower assembly by said frame.

8. The assembly as set forth in claim 7 wherein said spine is of metal.

9. The assembly as set forth in claim 2 wherein each of said hoops of said frame defines a flange for mounting said frame to the vehicle.

10. The assembly as set forth in claim 1 wherein said second material of said frame is a polymeric material.

11. The assembly as set forth in claim 1 wherein said housing includes a first shell and a second shell.

12. The assembly as set forth in claim 11 wherein said first shell defines a first rim and said second shell defines a second rim.

13. The assembly as set forth in claim 12 wherein said first and second rims are aligned with one another and said first and second shells are joined to one another to define said housing.

14. The assembly as set forth in claim 13 wherein said first and second shells are welded together.

15. The assembly as set forth in claim 1 wherein said housing has a thickness (t) ranging from 0.10 to 1.00 mm.

16. The assembly as set forth in claim 1 wherein said inlet is disposed on one end of said housing to define an upstream side of said housing.

17. The assembly as set forth in claim 16 wherein said outlet is disposed on the opposite end of said housing from said inlet to define a downstream side of said housing.

18. The assembly as set forth in claim 17 further including an evaporator disposed in said air channel of said housing for receiving the flow of air from said inlet and for dehumidifying and cooling the flow of air.

19. The assembly as set forth in claim 18 wherein said air channel of said housing includes a cool air path and a heated air path extending in parallel relationship to one another downstream of said evaporator;

20. The assembly as set forth in claim 19 further including a temperature valve disposed between said cool and heated air paths for apportioning the flow of cool air delivered from said evaporator between said cool and heated air paths.

21. The assembly as set forth in claim 20 further including a heater core disposed in said heated air path of said air channel for heating the flow of air apportioned into said heated air path by said temperature valve.

22. The assembly as set forth in claim 21 wherein said housing further defines a mixing chamber disposed downstream of said cool and heated air paths for receiving and mixing the cool air from said evaporator apportioned through said cool air path and the hot air from said heater core apportioned through said heated air path.

23. The assembly as set forth in claim 22 further including at least one zone valve disposed between said mixing chamber and said outlets for apportioning the flow of air from said mixing chamber between said outlets for directing the flow of air to the vehicle zones.

24. An HVAC module for controlling the temperature inside a vehicle comprising:
a first shell and a second shell having a thickness;
said first and second shells being of a first material pliable in response to a predetermined force;
said first shell defining a first rim and said second shell defining a second rim;
said first and second rims being aligned with one another and said first and second shells being welded together to define a unified housing;
said housing defining an inlet disposed on one end of said housing for receiving a flow of air and for defining an upstream side of said housing;
said housing defining at least one outlet for dispensing the flow of air to one or more zones of the vehicle;
said outlets being disposed on the opposite end of said housing from said inlet to define a downstream side of said housing;
said housing defining an air channel extending from said inlet on said upstream side of said housing to said outlets on said downstream side of said housing for conveying the flow of air there between;
a blower assembly adjacent to said inlet of said housing for propelling the flow of air into said air channel through said inlet of said housing;
an evaporator disposed in said air channel of said housing for receiving the flow of air from said inlet and for dehumidifying and cooling the flow of air;
said air channel of said housing including a cool air path and a heated air path extending in parallel relationship to one another downstream of said evaporator;
a temperature valve disposed in said air channel of said housing between said cool and heated air paths for apportioning the flow of cool air delivered from said evaporator between said cool air path and said heated air path;
a heater core disposed in said heated air path of said air channel for heating the flow of air apportioned into said heated air path by said temperature valve;
said housing defining a mixing chamber disposed downstream of said cool and heated air paths for receiving and mixing the cool air apportioned through said cool air path and the hot air apportioned through said heated air path;
at least one zone valve disposed between said mixing chamber and said outlets for apportioning the flow of air from said mixing chamber to said outlets for directing the air to one of the vehicle zones;
a frame defining a skeleton of a second material for maintaining structural integrity in response to a force greater than said predetermined force and for supporting said housing and said blower assembly on the vehicle;
said second material of said frame being a polymeric material;
each of said first and second shells of said housing having a thickness ranging from 0.1 to 1.0 mm;
said skeleton of said frame defining a plurality of hoops parallel and spaced from each other and a plurality of stringers being spaced from each other and interconnecting said hoops;
said skeleton of said frame defining a plurality of beams extending outwardly from one of said hoops of said frame to engage said blower assembly for supporting said blower assembly adjacent said housing;
said frame defining at least one flange for mounting said frame to the vehicle; and
a spine of metal interconnecting said hoops of said frame and extending outwardly from said frame to engage said blower assembly for reinforcing the support of said blower assembly by said frame;
said frame defining at least one valve seat; and
said frame defining a sealing surface for at least one of said valves.

25. A method of fabricating an HVAC module for controlling the temperature inside a vehicle comprising the steps of:
forming a housing defining an air channel of a first material being pliable in response to a predetermined force;
forming an inlet in the housing for receiving a flow of air and for delivering the flow of air to the air channel;
forming at least one outlet in the housing for dispensing the flow of air to one or more vehicle zones;
inserting a blower assembly adjacent to the inlet of the housing for propelling the flow of air through the air channel;
forming a frame defining a skeleton of a second material for maintaining structural integrity in response to a force greater than the predetermined force; and
engaging the skeleton of the frame to the housing and the blower assembly for supporting the housing and the blower assembly on the vehicle and for maintaining structural integrity in response to a force greater than the predetermined force.

26. The method as set forth in claim 25 wherein the step of forming the frame defining a skeleton is further defined by molding a plurality of hoops parallel and spaced from each other and a plurality of stringers being spaced from each other and interconnecting the hoops to define the skeleton of the frame.

27. The method as set forth in claim 26 including engaging a spine to the hoops of the skeleton of the frame and to the blower assembly for reinforcing the support of the blower assembly by the frame.

28. The method as set forth in claim 27 wherein the step of engaging the skeleton of the frame and to the blower assembly is further defined as engaging a spine of metal to the skeleton of the frame for reinforcing the support of the blower assembly by the frame.

29. The method as set forth in claim 25 wherein the step of forming the housing is further defined as forming a first shell and a forming second shell.

30. The method as set forth in claim 29 wherein the step of forming the first shell is further defined as forming a first shell having a first rim and the step of forming the second shell is further defined as forming a second shell having a second rim.

31. The method as set forth in claim 30 including aligning the first and second rims of the first and second shells preceeding the step of engaging the first shell to the second shell.

32. The method as set forth in claim 29 wherein the step of engaging the first shell to the second shell is further defined as welding the first shell to the second shell.

33. The method as set forth in claim 29 wherein the step of forming the first and second shells is further defined as molding the first and second shells.

34. The method as set forth in claim 33 wherein the step of molding the first and second shells is further defined as injection molding the first and second shells of a polymeric material.

35. The method as set forth in claim 29 wherein the step of forming the first shell is further defined as thermoforming the first shell on a first mold.

36. The method as set forth in claim 35 wherein the step of forming the second shell is further defined as thermoforming the second shell on a second mold.

37. The method as set forth in claim 36 wherein the step of forming the skeleton of the frame precedes the steps of forming the first and second shells and including inserting the frame into the first mold and thermoforming the first shell about the skeleton of the frame to mechanically engage the frame to the first shell.

38. The method as set forth in claim 37 including inserting the frame into the second mold before thermoforming the second shell to form the second shell about the skeleton of the frame to mechanically engage the frame to the second shell.

39. The method as set forth in claim 25 wherein the step of forming at least one outlet in the housing is further defined as forming at least one outlet on the end of the housing opposite of the inlet.

40. The method as set forth in claim 25 including inserting an evaporator into the air channel of the housing for cooling the flow of air.

41. The method as set forth in claim 40 including inserting a temperature valve in the air channel of the housing between the evaporator and the outlet to define a cool air path on one side of the temperature valve and a heated air path on the other side of the temperature valve and for apportioning the flow of cool air delivered from the evaporator between the cool and heated air paths.

42. The method as set forth in claim 41 including forming a mixing chamber in the housing between the cool and heated air paths and the outlets for mixing the air apportioned through the cool air path and the air apportioned through the heated air path.

43. The method as set forth in claim 42 further including the step of inserting a heater core into the heated air path of the housing for heating the flow of air apportioned into the heated air path by the temperature valve.

44. The method as set forth in claim 25 including inserting a zone valve in the air channel of the housing for apportioning the flow of air between a first vehicle zone and a second vehicle zone.

45. The method as set forth in claim 25 wherein the step of forming the frame is further defined as injection molding a frame of a polymeric material.

46. A method of fabricating an HVAC module for controlling the temperature inside a vehicle comprising the steps of:
thermoforming a first shell having a first rim of a first material pliable in response to a predetermined force and defining an air channel and a mixing chamber on a first mold;
inserting an evaporator for cooling the flow of air into the air channel of the first shell;
inserting a temperature valve in the air channel between the evaporator and the mixing chamber of the first shell for defining a cool air path on one side of the temperature valve and a heated air path on the other side of the temperature valve and for apportioning the flow of cool air delivered from the evaporator between the cool and heated air paths;
inserting a heater core into the heated air path of the first shell for heating the flow of air apportioned into the heated air path by the temperature valve;
inserting a zone valve in the air channel of the first shell for apportioning the flow of air from the mixing chamber between a first vehicle zone and to a second vehicle zone;
thermoforming a second shell having a second rim of the first material on a second mold;
aligning the first rim of the first shell with the second rim of the second shell;
welding the second shell to the first shell to define a housing;
forming an inlet in the housing for receiving a flow of air and for delivering the flow of air to the air channel of the housing;
forming at least one outlet on the end of the housing opposite of the inlet for dispensing the flow of air to one or more vehicle zones;
inserting a blower assembly externally of and adjacent to the inlet of the housing for propelling the flow of air through the inlet and into the air channel of the housing;
injection molding a frame defining a skeleton of a second material for maintaining structural integrity in response to a force greater than the predetermined force and having a plurality of hoops parallel and spaced from each other and a plurality of stringers being spaced from each other and interconnecting the hoops;
engaging the skeleton of the frame to the housing and the blower assembly to maintain structural integrity in response to a force greater than the predetermined force and for supporting the housing and the blower assembly on the vehicle; and
engaging a spine of metal to the hoops of the skeleton of the frame and to the blower assembly for reinforcing the support of the blower assembly by the frame.
